(19) United States
(12) Patent Application Publication
(10) Pub. No.: US 2016/0198127 A1
(43) Pub. Date: Jul. 7, 2016

(54) VIDEO MONITORING METHODS AND DEVICES

(71) Applicant: Xiaomi Inc., Beijing (CN)

(72) Inventors: Pengfei ZHANG, Beijing (CN); Yongfeng XIA, Beijing (CN); Heng QU, Beijing (CN); Tiejun LIU, Beijing (CN)

(73) Assignee: Xiaomi Inc., Beijing (CN)

(21) Appl. No.: 14/968,261

(22) Filed: Dec. 14, 2015

Related U.S. Application Data
(63) Continuation-in-part of application No. PCT/CN2015/077882, filed on Apr. 29, 2015.

(30) Foreign Application Priority Data
Dec. 31, 2014 (CN) 201410852301.7

(51) Int. Cl. H04N 7/18; H04N 5/247; H04N 5/44

(52) U.S. Cl. CPC H04N 7/181; H04N 5/44; H04N 5/247

(57) ABSTRACT

A video monitoring method includes: receiving a wireless signal sent from an external device; detecting whether a device identification carried in the wireless signal is the same as that of a bound wearable device; and stopping video monitoring if the device identification is the same as that of the wearable device. The present disclosure solves the problem that as long as the monitoring device is turned on it will continuously upload videos recorded to a server even though users are at home (thus leading to disclosure of user privacy), and achieves the effect of protecting user privacy by automatically stopping video monitoring when the monitoring device detects that a bound wearable device is nearby.

### PRIORITY STATEMENT

This application is a continuation-in-part of International Application No. PCT/CN2015/077882 with an international filing date of Apr. 29, 2015, which is based on and claims priority to Chinese Patent Application No. 201410852301.7, filed on Dec. 31, 2014, the entire contents of which are incorporated herein by reference.

### TECHNICAL FIELD

The present disclosure generally relates to the field of a smart device, and more particularly, to video monitoring methods and devices thereof.

### BACKGROUND

Smart cameras, a type of raising smart device, are widely used for residential monitoring (or residential surveillance).

When a user uses a smart camera to monitor his/her dwelling, the user only needs to turn on the smart camera, which is automatically connected to a router and then uploads videos it recorded to a server via the router. The user may monitor his/her dwelling by acquiring videos from the server by means of a smart mobile phone even though the user is out.

### SUMMARY

The present disclosure introduces methods and devices that conduct video monitoring (surveillance) only when a user is at home.

According to an aspect of the present disclosure, a video monitoring device comprises: a camera configured to capturing video images; a storage medium comprising a set of instructions for operating the camera; and a processor in communication with the camera and the storage medium. When executing the set of instructions, the processor is directed to receive a wireless signal sent from an external device, the wireless signal carrying an identification of the external device; determine that the external device is a target device based on the identification of the external device; and switch the camera from a first operation to a second operation when the wireless signal matches the identification of the target device.

According to another aspect of the present disclosure, a method for operating a video monitoring device comprises receiving, by a video monitoring device, a wireless signal sent from an external device, the wireless signal carrying an identification of the external device; determining, by the video monitoring device, that the external device is a target device based on the identification of the external device; and switching the video monitoring device from a first operation to a second operation when the wireless signal matches the identification of the target device.

According to yet another aspect of the present disclosure, a non-transitory processor-readable storage medium comprises a set of instructions for operating a video monitoring device. When executed by a processor of a video monitoring device, the set of instructions direct the processor to perform acts of: receiving a wireless signal sent from an external device, the wireless signal carrying an identification of the external device; determining that the external device is a target device based on the identification of the external device; and switching the video monitoring device from a first operation to a second operation when the wireless signal matches the identification of the target device.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a video monitoring method according to an exemplary embodiment.

FIG. 2A is a flow chart showing a video monitoring method according to another exemplary embodiment.

FIG. 2B is a schematic diagram showing an implementation of a video monitoring method according to another exemplary embodiment.

FIG. 2C is a flow chart showing a binding process involved in a video monitoring method according to another exemplary embodiment.

FIG. 2D is a schematic diagram showing implementation of a video monitoring method according to another exemplary embodiment.

FIG. 2E is a flow chart showing a binding process involved in a video monitoring method according to another exemplary embodiment.

FIG. 2F is a schematic diagram showing implementation of a video monitoring method according to another exemplary embodiment.

FIG. 3 is a structural block diagram of a video monitoring device according to an exemplary embodiment.

FIG. 4 is a structural block diagram of a video monitoring device according to another exemplary embodiment.

FIG. 5 is a block diagram of a video monitoring device according to an exemplary embodiment.

Specific embodiments of the present disclosure are shown by the above drawings, and more detailed description will be made hereinafter. These drawings and text description are not for limiting the scope of conceiving the present disclosure in any way, but for illustrating the concept of the present disclosure for those skilled in the art by referring to specific embodiments.

### DETAILED DESCRIPTION

Traditionally, when a video camera is on, it does not automatically turns itself off, regardless of whether its user is home or not. This is true even if the video camera is a smart camera. Once the user turns the smart camera on, it automatically connects to a server and upload videos it captured to the server. The smart camera servers its purpose of surveillance when the user is out. However, when the user is back home but forgets to turn the smart camera off, the user's privacy is at risk because the smart camera is still uploading the videos it takes to the server. The present disclosure introduces methods and devices that conduct video monitoring (surveillance) only when a user is not at home. At the user's wish, the devices may turn themselves off automatically when the user comes back. The methods and devices therefore may improve privacy protection of the user.

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

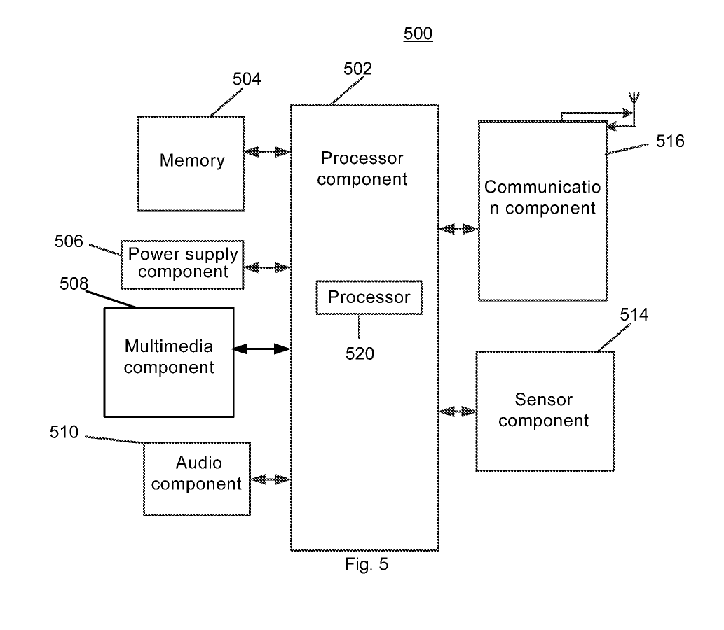

FIG. 5 is a block diagram of a video monitoring device according to an exemplary embodiment of the present disclosure. For example, the video monitoring device 500 may be a smart camera with computing and processing capability.

The video monitoring device 500 may include one or more components as below: a processor component 502, a memory 504, a power supply component 506, a multimedia component 508, an audio component 510, a sensor component 514, and a communication component 516.

The processor component 502 generally controls the overall operation of the device 500, such as operation associated with video monitoring. The processor component 502 may include one or more processors 520 for executing instructions so as to complete steps of the above method in part or in whole. In addition, the processor component 502 may include one or more modules for the convenience of interaction between the processor component 502 and other components.

The memory 504 is configured to store data of different types so as to support the operation of the device 500. Examples of the data include any application program or approach directive for operation of the device 500. For example, the memory 504 may store the above instructions to e executed by the processor 520. The instructions may be configured to realize methods of the present disclosure. The memory 504 may a volatile or non-volatile memory device of any type or combinations thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 506 provides power for components of the device 500. The power supply component 506 may include a power management system, one or more power supplies, and other components associated with generation, management and power distribution of the device 500.

The multimedia component 508 includes at least one camera. When the device 500 is under an image capturing mode or video mode, the camera may receive external multimedia data. The camera may be a fixed optical lens system or have focal length and optical zoom capacity.

The audio component 510 is configured to output and/or input audio signal. For example, the audio component 510 includes a microphone (MIC) and is configured to receive external audio signal. The audio signal received may be further stored in the memory 504 or sent out by the communication component 516. In some embodiments, the audio component 510 also includes a loudspeaker for outputting audio signal.

The sensor component 514 includes one or more sensors for providing the device 500 with state evaluation from all aspects. The sensor component 514 also may detect the position change of the device 500 or of a component thereof, the presence or absence of users' touch on the device 500, the direction or acceleration/deceleration of the device 500, and temperature variation of the device 500. The sensor component 514 may also include a proximity detector, which is configured to detect the presence of nearby objects in case of no physical touch. The sensor component 514 may also include an optical sensor, for example, CMOS or CCD image sensor for imaging. In some embodiments, the sensor component 514 may also include an acceleration sensor, a gyro sensor, a magnetic sensor, a pressure sensor, or a temperature sensor.

The communication component 516 is configured to facilitate wired communication or wireless communication between the device 500 and other equipment. The device 500 may be able to access to wired and/or wireless network based on communication standards, such as WiFi. In an exemplary embodiment, the communication component 516 receives by means of a broadcast channel the broadcast signal or broadcast-related information from external broadcast management systems. In an exemplary embodiment, the communication component 516 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the device 500 may implement methods disclosed in the present application through a set of instructions stored in a non-transitory computer-readable storage medium, such as the memory 504. The processor 520 of the device 500 may execute the set of instructions to conduct video monitoring. For example, the non-transitory computer-readable storage medium may be ROM, random access memory (RAM), CD-ROM, a magnetic tape, a floppy disk and an optical data storage device, etc.

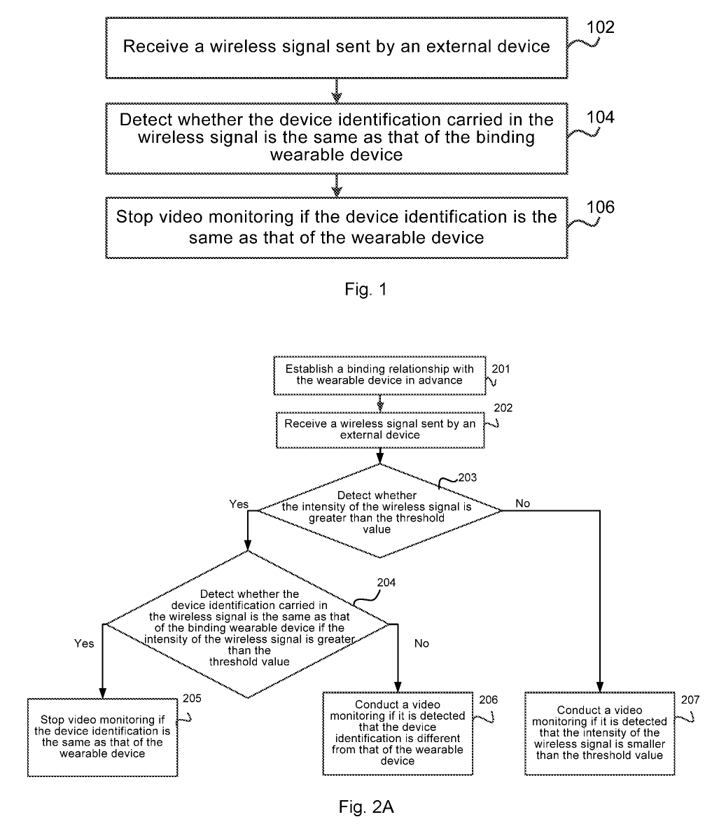

FIG. 1 is a flow chart showing a video monitoring method according to an exemplary embodiment. The method may be implemented in a video monitoring device such as the device 500. For example, the method may be implemented as a set of instructions stored in a non-transitory, computer-readable storage medium, such as the memory 504. The set of instructions may be executed by the processor 520. The method may include the following steps:

In Step 102, receiving a wireless signal sent from an external device.

In this step, the video monitoring device may be conducting video monitoring when receiving the wireless signal. The external device may be a wearable electronic device, such as a smart wristband, a smart watch, a smart bracelet, a smart necklace, a smart finger ring, or smart glasses, or other types of wearable smart device, a portable mobile device, such as a smart phone, or other type of electronic devices. For illustration purpose, the present disclosure takes a wearable device as an example to illustrate the method.

In Step 104, detecting whether device identification carried in the wireless signal is the same as that of a bound wearable device.

The wireless signal may comprise device identification. The video monitoring device may identify the device identification and compare the device identification with a device identification database stored therein, wherein the device identification database may store a plurality of identification of electronic devices that have been previously bound with the video monitoring device. As stated above, the electronic device may be a wearable smart device, mobile device, or other types of electronic devices, and the exemplary embodiment takes the wearable smart device as an example.

In Step 106, stopping video monitoring if the device identification is the same as that of the wearable device.

In conclusion, by receiving a wireless signal sent from the external device, detecting whether the device identification carried in the wireless signal is the same as that of the bound wearable device, and stopping video monitoring if the device identification is the same as that of the wearable device, the video monitoring method provided in the exemplary embodiment solves the problem that as long as the monitoring device is turned on it will continuously upload videos recorded to the server even though users are at home (thus leading to disclosure of user privacy), and achieves the effect of protecting user privacy by automatically stopping video monitoring when the monitoring device detects that the bound wearable device is nearby.

For implementation of the above method, a binding relationship is established between the monitoring device and the wearable device in advance so that after receiving a wireless signal sent from the external device the monitoring device may judge whether the external device is the bound wearable device and conducts or stops monitoring according to judged results. Reference will now be made by adopting an exemplary embodiment.

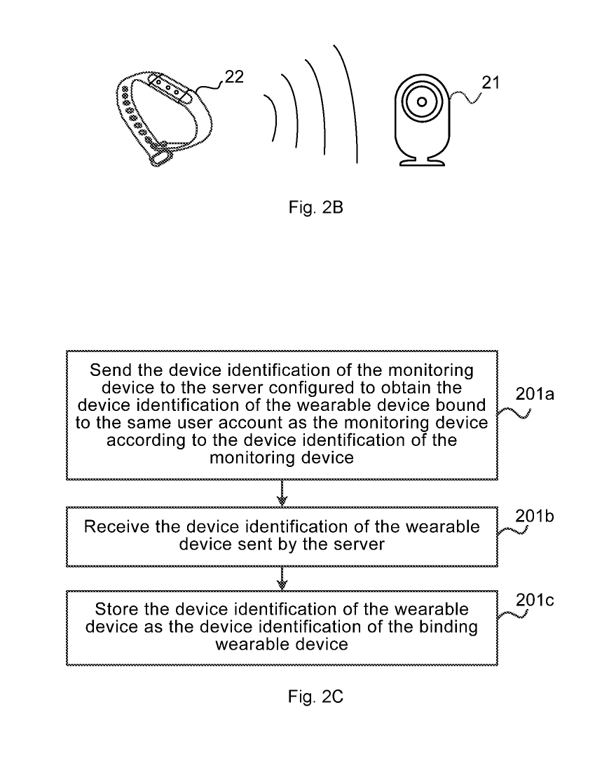

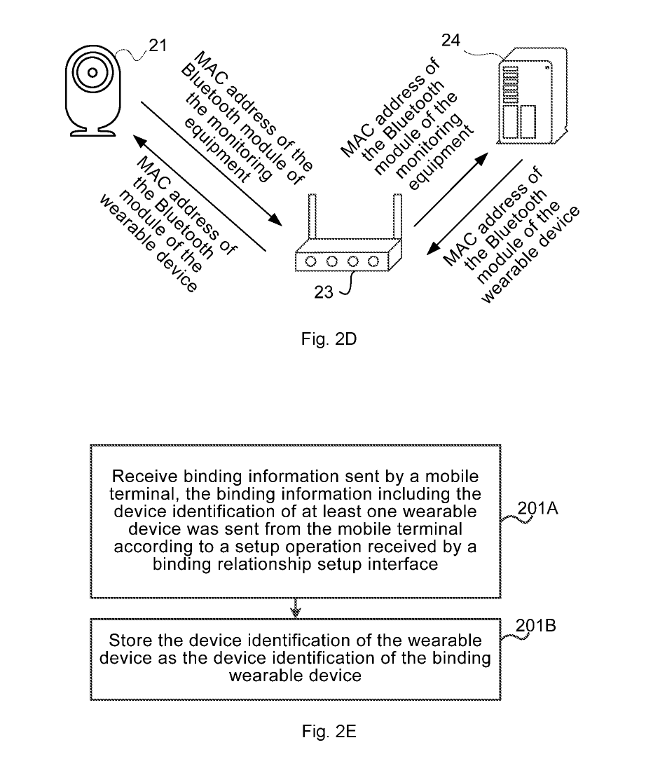

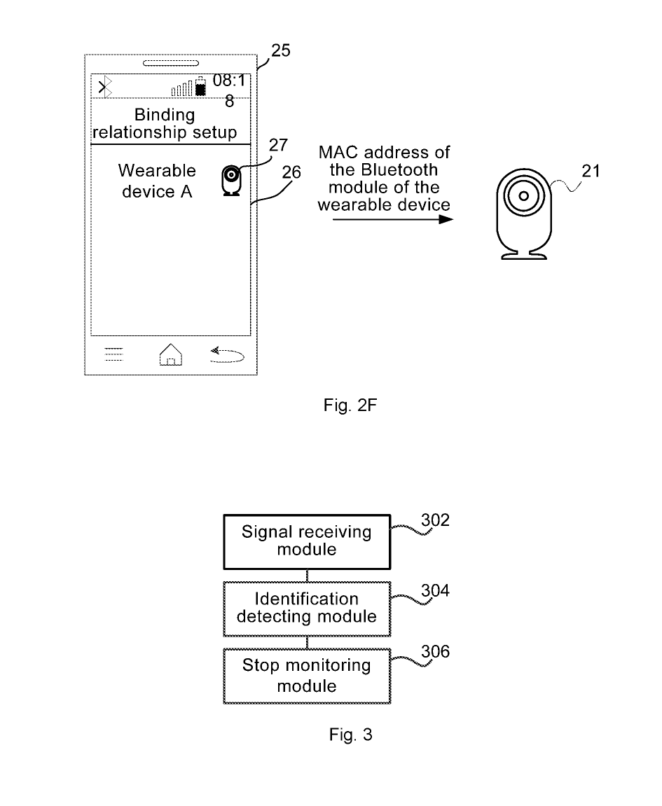

FIG. 2A is a flow chart showing a video monitoring method according to another exemplary embodiment. The method may be implemented in a video monitoring device such as the device 500. For example, the method may be implemented as a set of instructions stored in a non-transitory, computer-readable storage medium, such as the memory 504. The set of instructions may be executed by the processor 520. The method may include the following steps:

In Step 201, establishing a binding relationship with the wearable device in advance.

In this step, the video monitoring device may establish a binding relationship with an electronic device. For example, the video monitoring device may obtain identification of the electronic device and may recognize the electronic device via the identification when the electronic device is within a predetermined range from the video monitoring device. The electronic device may be any type of device as introduced above. For illustration purpose, the electronic device in this exemplary embodiment may be a wearable device.

The wearable device is an electronic device, which is able to transmit motion data and device information acquired by means of a wireless signal such as a Bluetooth signal or an infrared signal, etc. The wearable device may be a smart wristband, a smart watch, a smart bracelet, a smart necklace, a smart finger ring or smart glasses.

A user of the video monitoring device may establish in advance a binding relationship between the monitoring device and the wearable device so that the monitoring device may judge and/or determine whether an external device sending the wireless signal is the bound wearable device according to the wireless signal received.

In Step 202, the video monitoring device receives a wireless signal sent from an external device.

After startup or when in a working condition, the monitoring device may receive the wireless signal sent from the external device. The wireless signal may be a Bluetooth signal, a near field signal, a radio frequency (RF) signal, or or an invisible light signal such as an infrared signal, etc.

For example, the monitoring device is provided with a Bluetooth module, which is simultaneously turned on for receiving a Bluetooth signal sent from the external device when the video monitoring function of the monitoring device is started.

In Step 203, the video monitoring device determines whether an intensity of the wireless signal is greater than a preset threshold value.

The monitoring device detects the intensity of the wireless signal received and judges whether the external device is within the distance of monitoring according to the intensity of the wireless signal. The threshold value depends on the monitoring distance of the monitoring device. The monitoring device may compare the intensity of the wireless signal received with the preset threshold value. When the intensity of the wireless signal is greater than the preset threshold value, the monitoring device determines that the external device is within the distance of monitoring, and performs Step 204. When the intensity of the wireless signal is lower than the preset threshold value, the monitoring device determines that the external device is not within the distance of monitoring and consequently performs Step 207.

Alternatively, the video monitoring device may skip Step 203 and directly perform the Step 204 after the monitoring device receives the wireless signal sent from the external device.

In Step 204, the video monitoring device detects and/or determines whether the device identification carried in the wireless signal is the same as that of the bound wearable device (i.e., a target wearable device) if the intensity of the wireless signal is greater than the threshold value.

If the intensity of the wireless signal is greater than the threshold value, the monitoring device may process the wireless signal received and acquire the device identification of the external device carried in the wireless signal.

For example, if the wireless signal is a Bluetooth signal, the monitoring device may process the Bluetooth signal received and acquire a digital signal, and extract from the digital signal the device identification of the external device. The device identification may be the MAC (Media Access Control) address of the Bluetooth module in the external device.

After acquiring the device identification of the external device, the monitoring device may detect and/or determine whether the device identification is consistent with a device identification (i.e., a target device identification corresponding to the target wearable device) prestored in the bound wearable device. If the device identification is consistent and/or matches with the device identification (i.e., the target device identification) prestored in the bound wearable device, the monitoring device determines the external device as the bound wearable device (i.e., the target device), and Step 205 is performed. Otherwise, the monitoring device determines the external device is not the bound wearable device, and Step 206 is performed.

In Step 205, the video monitoring device stops video monitoring if the device identification is the same as that of the wearable device.

If the device identification of the external device is the same as that of the bound wearable device, the monitoring device determines that the user carrying the bound wearable device is within the distance of monitoring, and the monitoring device will stop video monitoring.

For example, as shown in FIG. 2B, taking an example in which the wearable device is a smart wristband, a binding relationship is established in advance between the monitoring device 21 and the smart wristband 22, and a Bluetooth signal carrying the device identification is continuously sent out by the wristband 22. The monitoring device 21 detects the Bluetooth signal sent from the smart wristband 22 and determines the intensity of the wireless signal. When it detects that the intensity is greater than the threshold value, it process and analyze the Bluetooth signal and acquires the device identification carried in the Bluetooth signal. As the device identification of the smart wristband 22 is prestored in the monitoring device 21, the monitoring device 21 may determine that the user carrying the wearable device bound in advance is within the distance of monitoring, and the monitoring device 21 will stop video monitoring.

It should be explained that after stopping video monitoring, the monitoring device will continue detecting the intensity of the wireless signal received. When the intensity becomes smaller than the threshold value, the monitoring device may immediately know that the external device is out of the distance of monitoring and conduct and/or resume video monitoring again.

In Step 206, the video monitoring device conducts a video monitoring if it is detected that the device identification is different from that of the target wearable device bound with the video monitoring device.

If the device identification of the external device is different from that of the bound wearable device, the monitoring device may determine that the external device is not the bound wearable device, and continue conducting a video monitoring, record videos and upload videos recorded to the server or save videos recorded in a storage device.

In Step 207, the video monitoring device conducts a video monitoring if it is detected that the intensity of the wireless signal is smaller than the preset threshold value.

When the intensity of the wireless signal received is smaller than the threshold value, the monitoring device may immediately know that the external device is out of the distance of monitoring and continue conducting a video monitoring.

In conclusion, by receiving a wireless signal sent from the external device, detecting whether the device identification carried in the wireless signal is the same as that of the bound wearable device, and stopping video monitoring if the device identification is the same as that of the wearable device, the video monitoring method provided in the exemplary embodiment solves the problem that as long as the monitoring device is turned on it will continuously upload videos recorded to a server even though users are at home (thus leading to disclosure of user privacy), and achieves the effect of protecting user privacy by automatically stopping video monitoring when the monitoring device detects that the bound wearable device is nearby.

In the exemplary embodiment, the monitoring device detects the intensity of the wireless signal sent from the external device. When the intensity of the wireless signal is smaller than the threshold value, the monitoring device may immediately know that the external device is out of the distance of monitoring and continue conducting a video monitoring. When the intensity of the wireless signal is greater than the threshold value, the monitoring device may detect the device identification carried in the wireless signal and determine whether or not to conduct a video monitoring according to detection results, thus solving the problem that when the monitoring device detects the bound wearable device, the monitoring device may stop video monitoring even though the wearable device is out of the distance of monitoring.

In the video monitoring method provided in the above embodiment, Step 201 may include following two possible implementation modes.

In the first possible implementation mode, as shown in FIG. 2C, Step 201 may include Step 201a and Step 201c.

In Step 201a, the monitoring device sends the device identification of the monitoring device to a server. The user of the video monitoring device may have previously registered an account with the server. The user may associate the account with both the video monitoring device, so that the video monitoring device may be able to connect to the server and log in the account. The user may also associate and/or bind the account with the wearable device, so that when the video monitoring device sends the identification of the external device to the server, the server may look up the device identification of the wearable device binding to the same user account as the monitoring device according to the device identification of the monitoring device.

The monitoring device sends the device identification of the monitoring device to the server, and the device identification may be the MAC address of the Bluetooth module in the monitoring device. On the basis of the device identification sent from the monitoring device, the server may look up account information about the user binding the monitoring device from a table in which the binding relationship between the monitoring device and user account is prestored. Taking an example in which the device identification of the monitoring device is the MAC address of the Bluetooth module, the structure of the table of the binding relationship between the monitoring device and the user account may be as shown in Table I.

TABLE I

| Device ID of a video monitoring | |
|---|---|
| device | User account |
| 00:11:22:33:AA:BB | Zhangsan |
| 00:11:22:33:AA:BC | Lisi |
| 00:11:22:33:AA:BD | Wangwu |

The server may look up the corresponding user account according to the device identification of the monitoring device, and look up the device identification of the bound wearable device according to the user account information. The device identification of the wearable device may be the MAC address of the Bluetooth module in the wearable device. Wherein, the table of the binding relationship between the wearable device and user account may be stored in the server, the table structure of which may be as shown in Table II.

TABLE II

| Device identification of the wearable | |
|---|---|
| device | User account |
| 00:11:22:33:AA:CC | Zhangsan |
| 00:11:22:33:AA:CD | Lisi |
| 00:11:22:33:AA:CE | Wangwu |

For example, if the device identification of the monitoring device sent from the monitoring device to the server is “00:11:22:33:AA:BB”, the server may determine that the corresponding user account is “Zhangsan,” and accordingly, the corresponding wearable device bound to “Zhangsan” has a device identification “00:11:22:33:AA:CC.”

It should be explained that the same user account may be bound with a plurality of wearable devices or a plurality of monitoring device, on which the present disclosure makes no restriction.

In Step 201b, the monitoring device receives the device identification of the wearable device sent from the server.

After looking up the device identification of the wearable device, the server sends the device identification of the wearable device to the monitoring device. Correspondingly, the monitoring device receives the device identification of the wearable device.

For example, as shown in FIG. 2D, the video monitoring device 21 sends the MAC address of the Bluetooth module in the monitoring device 21 to the server 24 via a connected router 23. The server 24 looks up the MAC address of the Bluetooth module in the wearable device that binds to the same user account as the monitoring device 21 according to the MAC address of the Bluetooth module in the monitoring device, and sends the MAC address of the Bluetooth module of the wearable device to the monitoring device 21.

In Step 201c, the monitoring device stores the device identification of the wearable device as the device identification of the bound wearable device.

The monitoring device determines and stores the received device identification of the wearable device as the device identification of the bound wearable device.

In the second possible implementation mode, as shown in FIG. 2E, Step 201 may include Step 201A and Step 201B.

In Step 201A, the monitoring device receives binding information sent from a mobile terminal, wherein the binding information includes device identifications of at least one wearable device, and the binding information was sent from the mobile terminal according to a setup operation received at a binding relationship setup interface of the mobile terminal.

The mobile terminal may be connected to the monitoring device by Bluetooth, and may receive the device identification of the wearable device inputted by the user on the binding relationship setup interface and send device identification of the wearable device to the monitoring device. Correspondingly, the monitoring device receives the device identification of the wearable device.

In Step 201B, the monitoring device stores the device identification of the wearable device as the device identification of the bound wearable device.

For example, as shown in FIG. 2F, the user may run monitoring device management software installed in the mobile terminal 25 and establish Bluetooth connection with the monitoring device 21. After acquiring the MAC address of the Bluetooth module in the wearable device, the mobile terminal 25 displays a camera icon 27 on the binding relationship setup interface 26 for the user to choose. When the user chooses the camera icon 27, the mobile terminal sends the MAC address of the Bluetooth module to the monitoring device 21 according to the user's choice. The monitoring device 21 determines the MAC address of the Bluetooth module as the device identification of the bound wearable device.

It should be explained that the user may also log onto the monitoring device management software using the user account. After searching out the monitoring device, the device identification of the wearable device binding with the user account is automatically sent to the monitoring device, which receives and stores the device identification of the wearable device.

The following is the embodiment of a device in the present disclosure, which may be configured to carry out the embodiment of the method in the present disclosure. For any details that are not disclosed in the following embodiment, please refer to the above embodiments of the above methods in the present disclosure.

It should be note that in addition to stopping video monitoring when the wireless signal of the wearable device stronger than the threshold value, the above method may conduct a reverse operation. For example, the video monitoring device may stop the video monitoring operation when there is no wireless signal from the wearable device (target device) that is bound to the video monitoring device or when the wireless signal is from the target device but not stronger than the threshold value. But when the video monitoring device detects the wireless signal from the target device and the intensity of the wireless signal is stronger than the threshold value, the video monitoring device may start the video monitoring operation. This way, the video monitoring device may be implemented to record activities of the user of the wearable device, a.k.a, the video monitoring device records only when the user of the wearable device is nearby.

It should also be note that in addition to the video monitoring device, the above-introduced method may also be implemented in other electronic device, such as a smart air conditioning system, a smart light, a smart humidifier, or other home appliance.

For example, when the above-mentioned method is implemented to a smart lighting system, the smart lighting system may detect the wireless signals sent from the target wearable device. When intensity of the signals from the wearable device is stronger than the preset threshold value, the smart lighting system may determine that the user who wears the target wearing device is close enough, and the smart lighting system may commit to turn certain light on. The light may be a light close to where the user locates. For example, when the user walks back home from work, the smart lighting system may turn on a light outside the user's home first, and then when the user opens the door and walks in his/her home, turns on the lights in the living room, and turns on the light in the bedroom when the user walks in the bedroom.

The smart lighting system may turn on the light according to the signal intensity of the target wearing device alone, or may also taking into account the current time when determining whether to turn on the light. For example, the smart lighting system may turn on a light when the signal intensity of the target wearable device is stronger than the threshold value and when the environment of the smart light system is dark enough.

Conceivably, the above-method may also be applied to other home appliances such as a smart air conditioning system, and/or a smart humidifier, etc.

FIG. 3 is a structural block diagram of a video monitoring device according to an exemplary embodiment. The video monitoring device may have a hardware structure as the device 500. The above-introduced method may be implemented as a set of instructions stored in a non-transitory, computer-readable storage medium of the video monitoring device, such as the memory 504. Alternatively, the above-introduced methods may be implemented in the video monitoring device as hardware modules or a combination of software and hardware modules. The video monitoring device may include:

A signal receiving module 302, configured to receive a wireless signal sent from an external device;

An identification detecting module 304, configured to detect whether the device identification carried in the wireless signal received by the signal receiving module 302 is the same as that of the bound wearable device; and

A stop monitoring module 306, configured to stop video monitoring if the identification detecting module 304 detects that the device identification is the same as that of the wearable device.

In conclusion, by receiving a wireless signal sent from the external device, detecting whether the device identification carried in the wireless signal is the same as that of the bound wearable device, and stopping video monitoring if the device identification is the same as that of the wearable device, the video monitoring device provided in the exemplary embodiment solves the problem that as long as the monitoring device is turned on it will continuously upload videos recorded to a server even though users are at home (thus leading to disclosure of user privacy), and achieves the effect of protecting user privacy by automatically stopping video monitoring when the monitoring device detects that the bound wearable device is nearby.

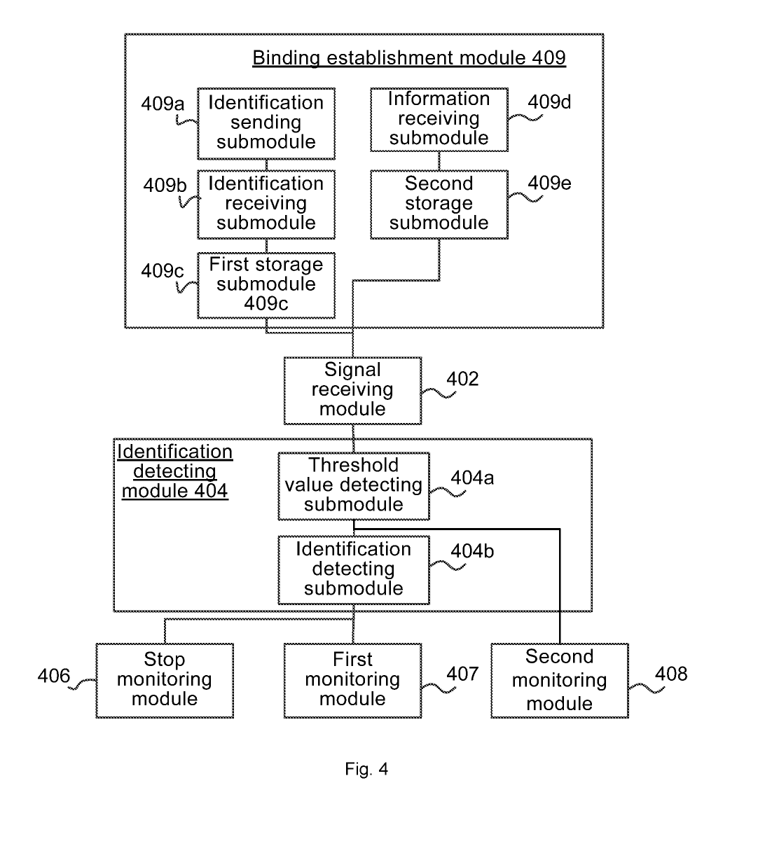

FIG. 4 is a structural block diagram of a video monitoring device according to another exemplary embodiment. The video monitoring device may have a hardware structure as the device 500. The above-introduced method may be implemented as a set of instructions stored in a non-transitory, computer-readable storage medium of the video monitoring device, such as the memory 504. Alternatively, the above-introduced methods may be implemented in the video monitoring device as hardware modules or a combination of software and hardware modules. The video monitoring device may include:

A signal receiving module 402, configured to receive a wireless signal sent from the external device;

An identification detecting module 404, configured to detect whether the device identification carried in the wireless signal received by the signal receiving module 402 is the same as that of the bound wearable device; and

A stop monitoring module 406, configured to stop video monitoring if the identification detecting module 404 detects that the device identification is the same as that of the wearable device.

Additionally, the identification detecting module 404 may include:

A threshold value detecting submodule 404a, configured to detect whether the intensity of the wireless signal received by the signal receiving module is greater than the threshold value; and

An identification detecting submodule 404b, configured to detect whether the device identification carried in the wireless signal is the same as that of the bound wearable device if the threshold value detecting submodule detects that the intensity of the wireless signal is greater than the threshold value.

Additionally, the device may also include:

A first monitoring module 407, configured to conduct a video monitoring if the identification detecting module 404 detects that the device identification is different from that of the wearable device; or

A second monitoring module 408, configured to conduct a video monitoring if the identification detecting module 404 detects that the intensity of the wireless signal is smaller than the threshold value.

Additionally, the device may also include: a binding establishment module 409, configured to establish a binding relationship with the wearable device in advance. The binding establishment module 409 may include:

An identification sending submodule 409a, configured to send the device identification of the monitoring device to the server configured to look up the device identification of the wearable device binding the same user account as the monitoring device according to the device identification of the monitoring device;

An identification receiving submodule 409b, configured to receive the device identification of the wearable device sent from the server; and

A first storage submodule 409c, configured to store the device identification of the wearable device received by the identification receiving submodule 409b as the device identification of the bound wearable device.

Additionally, the binding establishment module 409 may include:

An information receiving submodule 409d, configured to receive binding information sent from a mobile terminal, the binding information including device identifications of at least one wearable device, and the binding information was sent from the mobile terminal according to a setup operation received at a binding relationship setup interface; and

A second storage submodule 409e, configured to store the device identification of the wearable device received by the information receiving submodule 409d as the device identification of the bound wearable device.

In conclusion, by receiving a wireless signal sent from the external device, detecting whether the device identification carried in the wireless signal is the same as that of the bound wearable device, and stopping video monitoring if the device identification is the same as that of the wearable device, the video monitoring device provided in the exemplary embodiment solves the problem that as long as the monitoring device is turned on it will continuously upload videos recorded to a server even though users are at home (thus leading to disclosure of user privacy), and achieves the effect of protecting user privacy by automatically stopping video monitoring when the monitoring device detects that the bound wearable device is nearby.

In the exemplary embodiment, the monitoring device detects the intensity of the wireless signal sent from the external device. When the intensity of the wireless signal is smaller than the threshold value, the monitoring device may immediately know that the external device is out of the distance of monitoring and continue conducting a video monitoring. When the intensity of the wireless signal is greater than the threshold value, the monitoring device may detect the device identification carried in the wireless signal and determine whether or not to conduct a video monitoring according to detection results, thus solving the problem that when the monitoring device detects the bound wearable device, the monitoring device may stop video monitoring even though the wearable device is out of the distance of monitoring.

With regard to the device in the above embodiment, detailed description of specific modes for conducting operation of modules has been made in the embodiment related to the methods, no detailed illustration will be made herein.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the distance of the present disclosure only be limited by the appended claims.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure should only be limited by the appended claims.

1. A video monitoring device, comprising:
a camera configured to capturing video images;
a storage medium comprising a set of instructions for operating the camera; and
a processor in communication with the camera and the storage medium, wherein when executing the set of instructions, the processor is directed to:
receive a wireless signal sent from an external device, the wireless signal carrying an identification of the external device;
determine that the external device is a target device based on the identification of the external device; and
switch the camera from a first operation to a second operation when the wireless signal matches the identification of the target device.

2. The device of claim 1, wherein the target device is a wearable smart electronic device bound with the video monitoring device.

3. The device of claim 1, wherein the first operation comprises a video monitoring operation; and
the second operation comprises stopping the video monitoring operation.

4. The device of claim 1, wherein the first operation comprises stopping a video monitoring operation; and
the second operation comprises the video monitoring operation.

5. The device of claim 1, wherein the processor is further directed to:
determine that the external device is the target device when the identification of the external device matches an identification of the target device and when an intensity of the wireless signal is greater than a threshold value;
conduct the first operation when the identification in the wireless signal does not match the identification of the target device; and
conduct the first operation when the intensity of the wireless signal is smaller than the threshold value.

6. The device of claim 5, wherein the processor is further directed to establish a binding relationship between the target device and the video monitoring device, including:
receiving binding information sent from a mobile terminal, the binding information including the identification of the target device; and
storing the identification of the target device as the device identification of the bound device.

7. The device of claim 5, wherein the processor is further directed to:
send an identification of the video monitoring device to a server, the server being configured to obtain an identification of a device bound to the video monitoring device according to the identification of the monitoring device;
receive the identification of the bound device from the server; and
store the identification of the bound device as the identification of the target device.

8. A method for operating a video monitoring device, comprising:
receiving, by a video monitoring device, a wireless signal sent from an external device, the wireless signal carrying an identification of the external device;
determining, by the video monitoring device, that the external device is a target device based on the identification of the external device; and
switching the video monitoring device from a first operation to a second operation when the wireless signal matches the identification of the target device.

9. The method of claim 8, wherein the target device is a wearable smart electronic device bound with the video monitoring device.

10. The method of claim 8, wherein the first operation comprises a video monitoring operation; and
the second operation comprises stopping the video monitoring operation.

11. The method of claim 8, wherein the first operation comprises stopping a video monitoring operation; and
the second operation comprises the video monitoring operation.

12. The method of claim 8, further comprising:
determining, by the video monitoring device, that the external device is the target device when the identification of the external device matches an identification of the target device and when an intensity of the wireless signal is greater than a threshold value;
conducting, by the video monitoring device, the first operation when the identification in the wireless signal does not match the identification of the target device; and
conducting, by the video monitoring device, the first operation when the intensity of the wireless signal is smaller than the threshold value.

13. The method of claim 12, further comprising establishing a binding relationship between the target device and the video monitoring device, including:
receiving, by the video monitoring device, binding information sent from a mobile terminal, the binding information including the identification of the target device; and
storing, by the video monitoring device, the identification of the target device as the device identification of the bound device.

14. The method of claim 12, further comprising:
sending, by the video monitoring device, an identification of the video monitoring device to a server, the server being configured to obtain an identification of a device bound to the video monitoring device according to the identification of the monitoring device;
receiving, by the video monitoring device, the identification of the bound device from the server; and
storing, by the video monitoring device, the identification of the bound device as the identification of the target device.

15. A non-transitory processor-readable storage medium,
comprising a set of instructions for operating a video monitoring device, wherein when executed by a processor of a video monitoring device, the set of instructions direct the processor to perform acts of:
receiving a wireless signal sent from an external device, the wireless signal carrying an identification of the external device;
determining that the external device is a target device based on the identification of the external device; and
switching the video monitoring device from a first operation to a second operation when the wireless signal matches the identification of the target device.

16. The storage medium of claim 15, wherein the first operation comprises a video monitoring operation; and
the second operation comprises stopping the video monitoring operation.

17. The storage medium of claim 15, wherein the first operation comprises stopping a video monitoring operation; and
the second operation comprises the video monitoring operation.

18. The storage medium of claim 15, wherein the set of instructions further directs the processor to perform acts of:
determining that the external device is the target device when the identification of the external device matches an identification of the target device and when an intensity of the wireless signal is greater than a threshold value;
conducting the first operation when the identification in the wireless signal does not match the identification of the target device; and
conducting the first operation when the intensity of the wireless signal is smaller than the threshold value.

19. The storage medium of claim 18, wherein the set of instructions further directs the processor to perform acts of establishing a binding relationship between the target device and the video monitoring device, including:
receiving binding information sent from a mobile terminal, the binding information including the identification of the target device; and
storing the identification of the target device as the device identification of the bound device.

20. The storage medium of claim 18, wherein the set of instructions further directs the processor to perform acts of:
sending an identification of the video monitoring device to a server, the server being configured to obtain an identification of a device bound to the video monitoring device according to the identification of the monitoring device;
receiving the identification of the bound device from the server; and
storing the identification of the bound device as the identification of the target device.
